(19) United States
(12) Patent Application Publication
(10) Pub. No.: US 2004/0123320 A1
(43) Pub. Date: Jun. 24, 2004

(54) Method and system for providing an interactive guide for multimedia selection

(76) Inventors: Mike Daily, Thousand Oaks, CA (US); David W. Payton, Calabasas, CA (US); Jason Fox, Thousand Oaks, CA (US)

Correspondence Address: TOPE-MCKAY & ASSOCIATES, 23852 PACIFIC COAST HIGHWAY #311, MALIBU, CA, 90265, US

(21) Appl. No.: 10/329,330

(22) Filed: Dec. 23, 2002

(51) Int. Cl. G06F 13/00; H04N 5/445; G06F 3/00

(52) U.S. Cl. 725/61; 725/43; 725/39; 725/40

(57) ABSTRACT

An interactive multimedia selection guide is provided. The guide includes a computer system having a processor, a memory, an input for receiving user input, an input for receiving programs from a program database, and an output for sending display information to a visual display. The interactive guide navigates through a graph structure of multimedia program/channel sources in the program database. The graph structure includes a plurality of nodes representing multimedia and contextual information. Programs and channels as well as groups of programs and channels are represented as nodes in the graph, and as icons or native format representations on a display device. Navigation through the graph structure is performed by allowing the user to affect panning of the visual display, zooming-in of a desired portion of the visual display, zooming-out of a desired portion of the visual display, selection of a node represented by an icon, and retracing.

### BACKGROUND

1. Technical Field

The present invention is related to the field of television program selection. More specifically, a method and system is presented for providing an interactive guide for television program selection which allows a user to perform various operations such as panning and zooming through iconic and native format representations of media sources and selecting media sources for playback.

2. Discussion

Currently television channel guides are based on a two-dimensional grid representation of program schedules typically laid out chronologically across the screen. Information relevant to these program guides can be found in U.S. Pat. Nos. 5,809,204; 4,706,121; 4,847,696; 4,885,775; 5,231,493; 5,479,266; 5,940,073; 5,523,796; 5,559,548; 5,585,838; 5,585,866; 5,623,613; 5,886,690; and 5,844,620. These onscreen program “guides” are all text based. With both cable and satellite program delivery systems currently delivering hundreds of distinct channels, and plans for hundreds more, this user interface approach is inadequate for finding programming that a user desires to watch.

What is needed is an interactive approach that is both rapid and intuitive. An approach that enables users to gather information more easily for making program or content viewing selections is needed. It would also be helpful to compensate for low screen resolutions inherent in most NTSC broadcast television sets by minimizing the amount of text and enabling rapid visual searching; which is not possible using grid-based screen guides. It would also be useful to have an approach that does not require users to remember channel numbers to make quick navigation selections.

### SUMMARY

In one embodiment of the present invention, an interactive multimedia selection apparatus comprises a computer system including a processor, a memory coupled with the processor, a first input coupled with the processor for receiving user input, a second input for receiving data from a program database, and an output coupled with the processor for sending display information to a visual display. The computer system further comprises means operating in its processor and memory for navigating or browsing through a graph structure of multimedia sources in the program database. The graph structure includes a plurality of nodes including a starting node, a current node representing a current point of view in the graph structure of the means for navigating, and a plurality of connected nodes. The connected nodes are ultimately connected with the starting node through the graph structure. Each node represents at least one type of content selected from the group of links to other nodes, multimedia contents, and contextual information. The means for navigating/browsing further includes means for providing an output to a visual display with the output including icons representing nodes directly connected with current node. Further, the means for navigating/browsing includes means for receiving user input in the form of a user command through the first input into the computer system for controlling the navigation of the interactive multimedia selection apparatus in order to allow the user to cause panning of the visual display, zooming-in of a desired portion of the visual display, zooming-out of a desired portion of the visual display, selection of a node represented by an icon, and retracing. These functions allow a user to provide input to the browser for navigation control. In response to a user command for panning, the means for navigating/browsing displays information through the output to the visual display to effect a panning action in order to cause the icons to move in a panning motion on the display in order to provide the user with a better view of the icons. In response to a user command for zooming in, the means for navigating/browsing displays information through the output to the visual display to effect a zooming-in action in order to allow the user to see more detail in a desired portion of the visual display. In response to a user command for zooming out, the means for navigating/browsing displays information through the output to the visual display to effect a zooming-out action in order to allow the user to see a larger area of the visual display. Additionally, in response to a user command for selecting a node represented by an icon, the means for navigating/browsing displays information through the output to the visual display to effect an opening the respective node to display its contents on the visual display. Finally, in response to a user command for retracing, the means for navigating/browsing sends display information through the output to the visual display to navigate to the immediately previous current node; whereby the user can interactively navigate through a plurality of media sources to and select desired programming for display on a visual display in a simple and visually intuitive manner.

In a further aspect of the present invention, the nodes are represented in the display information sent through the output as graphical icons, with each icon depicting a representation of the content in the database represented by the node.

In a still further aspect of the present invention, icons representing nodes including multimedia content play a reduced version of the multimedia content in real-time, thereby allowing a user to see the underlying content of a media source icon prior to fully viewing the content.

In another aspect of the present invention, the user input includes a selection means that allows a user perform a preliminary selection in which an icon preliminarily selected is enhanced so that its multimedia play is amplified relative to that of the other icons, whereby the multimedia content play of a preliminarily selected icon stands out from the other icons to allow a user to better determine its contents.

In yet another aspect of the present invention, the first input includes a user input device selected from a group consisting of television remote controls, computer mice, microphones, and eye-trackers; and in a still further aspect, the apparatus further comprises a visual display device for receiving output from the processor for display to a user.

In another aspect of the present invention, the means for navigating/browsing further comprises a means for displaying all of the multimedia sources in the program database in a timeline matrix structure; whereby a user may also browse through the multimedia sources to search for desired content.

Further, in another aspect of the present invention, in order to permit customization, the means for navigating further comprises a means for adjusting the response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

In a still further aspect of the present invention, the user input includes a selection means that allows a user to perform a preliminary selection in which the icon preliminary selected plays a reduced version of the multimedia content in real-time, thereby allowing a user to see the underlying content of a media source icon prior to fully viewing the content.

The above aspects may be incorporated either alone or in conjunction with other aspects into various embodiments of the invention. The exact combinations are not mentioned here for sake of clarity as they are readily ascertainable by those in the art. Furthermore, the “means” discussed above, where applicable, may be incorporated into a computer program product embodiment stored on a computer readable medium for use on a general purpose or special purpose computer, or may be tailored as “steps” in a method embodiment of the present invention.

### BRIEF DESCRIPTION OF THE DRAWINGS

These and other features, aspects, and advantages of the present invention will become better understood with regard to the following description, appended claims, and accompanying drawings where:

FIG. 1(a) is a screenshot of an interactive television program selection guide according to the present invention, wherein media sources and categories are represented by icons;

FIG. 1(b) is a screenshot of an alternate, matrix view available to users of the present invention for viewing information on a timeline;

FIG. 2(a) through FIG. 2(c) are screenshots illustrating the zooming-in and zooming-out operations of the present invention;

FIG. 3 is a block diagram depicting an embodiment of the computer system of the present invention;

FIG. 4 is an illustrative diagram depicting the computer system of the present invention in cooperation with a satellite television programming source, a television, and a variety of remote control types;

FIG. 5 is an alternate block diagram illustrating components of the present invention;

FIG. 6 is an illustrative diagram of a graph structure of program sources to aid in explaining the navigation of the interactive guide through a database of media sources;

FIG. 7 is a flowchart depicting the operations of the present invention;

FIG. 8 is an illustrative diagram to aid in explaining the panning function of the present invention; and

FIG. 9 is an illustrative diagram depicting a computer program product of the present invention, in the specific form of a compact disc.

### DETAILED DESCRIPTION

The present invention provides an apparatus, a method, and a computer program product for providing an interactive guide for multimedia selection/television program selection. It should be understood that this description is not intended to limit the invention. On the contrary, the present invention is intended to cover alternatives, modifications and equivalents, which are included in the spirit and scope of the invention as defined by the appended claims. Furthermore, in the following detailed description of the present invention numerous specific details are set forth in order to provide a thorough understanding of the present invention. However, it will be obvious to one of ordinary skill in the art that the present invention may be practiced without the specific details.

As will be appreciated by one of skill in the art, the present invention may be embodied as an interactive television guide apparatus, as a method, or as a computer program product. Accordingly, the present invention may take the form of an entirely hardware embodiment or an embodiment combining hardware and software aspects. Furthermore, the present invention may take the form of a computer program product on a computer-readable storage medium having computer-readable program means embodied in the medium. Any suitable computer readable medium may be utilized including hard disks, CD-ROMs, optical storage devices, or magnetic storage devices.

In order to provide a working frame of reference, first a glossary of terms used in the description and claims is given as a central resource for the reader. The glossary is not intended to provide specific limitations regarding the terms used, but rather, is intended to assist the reader by providing a general feel for some of the terms used herein. After the glossary, a brief introduction to the physical embodiments of the present invention is provided prior to discussing its other aspects.

Glossary

Before describing the specific details of the present invention, it is useful to provide a centralized location in which various terms used herein and in the claims. The terms defined are as follows:

Graph—Most simply stated, a graph is a collection of nodes and edges. In this case, the nodes represent multimedia content. The term graph is intended to convey the meaning commonly used in the computer arts.

Means—The term “means” as used with respect to this invention generally indicates a set of operations to be performed on a computer. Non-limiting examples of “means” include computer program code (source or object code) and “hard-coded” electronics. The “means” may be stored in the memory of a computer or on a computer readable medium.

Native Format Representation—This term generally means that the underlying media of a node is depicted in a reduced form, but is still true to the native form of the media. For example, video media would be represented as a small version of the video, playing in real-time, while audio media would be represented as a continuously playing sound, and text media would be represented as a miniaturized version of the text.

Physical Embodiments of the Present Invention

The present invention has three principal physical embodiments. The first is a computer system apparatus for providing an interactive guide for television program selection. The second physical embodiment is a method, typically software, operated on a data processing system. The third principal physical embodiment is a computer program product. The computer program product generally represents computer readable code stored on a computer readable medium such as an optical storage device, e.g., a compact disc (CD) or digital versatile disc (DVD), or a magnetic storage device such as a floppy disk or magnetic tape. Other, non-limiting examples of computer readable media include hard disks and flash-type memories. These embodiments will be described in more detail below.

Overview

The present invention generally provides a technique for interacting with large databases of program (typically television programs) selections by enabling a user to navigate program and channel information using interactive panning, zooming, and other operations. Referring to the relationships between components in the database, the database is typically in the form of a graph data structure, and more particularly, it may be in the form of a tree data structure. Furthermore, the data in the database is preferably stored with graphical icons that typically represent the data content. The graphical icons may, for example in the case of audio files, take the form of a symbolic icon generally representing a sound, such as a graphical icon of a musical note or a speaker, or they may take a specific contextual form such as a miniaturized version of an album cover. On the other hand, the data in the database may be stored as a native format representation of the underlying data. In other words, motion picture data could be represented as a miniaturized version of the movie playing, or audio data could be represented as a sound. Using the present invention, users can zoom into visual icons and see expanded channel or program information at higher levels of detail.

One of the primary objects of the present invention is to provide user operations that are both rapid and intuitive, enabling users to gather information and make program or content viewing selections more easily than is possible with current television channel guides. Because of the graphical nature of the interactive guide for television program selection described herein, it is able to compensate for low screen resolutions inherent in most NTSC broadcast television sets by minimizing the amount of text and enabling rapid, visual searches that are not possible using grid-based screen guides. The approach detailed herein also does not require users to remember channel numbers in order to make quick navigation selections.

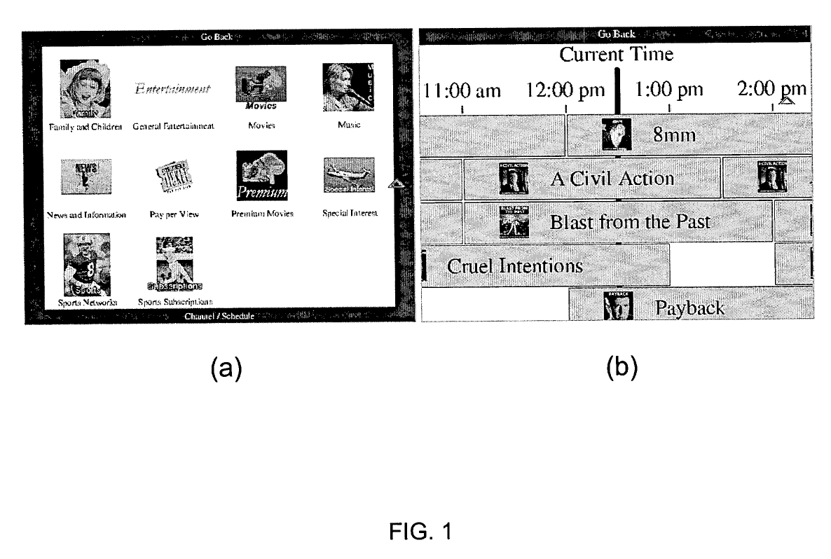

Typical views provided by the interactive guide of the present invention are depicted in FIG. 1(a) and FIG. 1(b). The view shown in FIG. 1(a) is a screenshot depicting an embodiment of the present invention in which program sources are categorized by program type, e.g., general entertainment, movies, music, news, pay-per-view, etc., with each category providing access to media sources or to other navigational layers. By selecting a category or provider, the interactive guide dynamically zooms into the next layer, displaying the contents of that “node” within the database of data sources as a panel such as that shown in FIG. 1(a). A panel representing the contents of a node may include any type of multimedia information, non-limiting examples of which include icons for content or provider, graphical schedules, reviews, photos of actors and actresses, biographical data, scripts, sounds, etc. The icons may be presented against a plain background, as depicted in FIG. 1(a), or they may be superimposed over a currently playing selection so that a user may “channel surf” while still viewing a selected program.

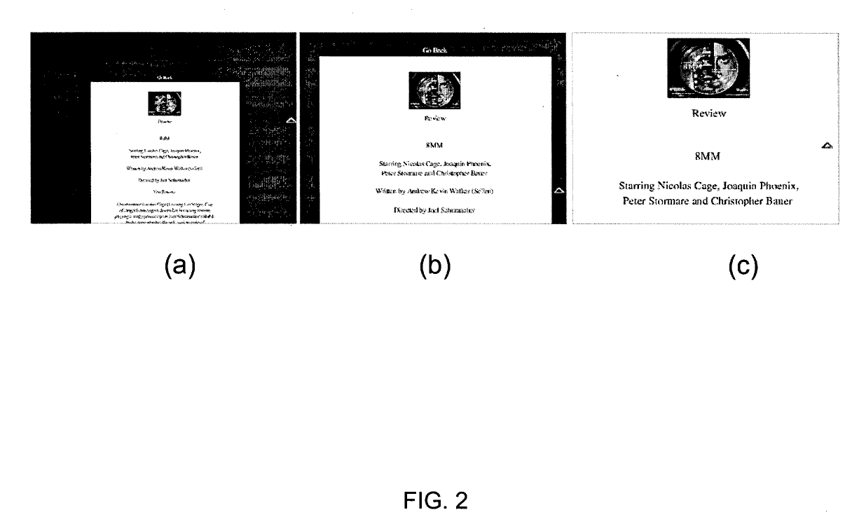

The user navigates by panning, zooming, and selecting. Panning allows a user to view information that has moved off of the screen (or that is off screen to begin with). Zooming allows the user to customize the level of detail visible in the display at any time and provides support for a wide range of screen resolutions, including low resolution NTSC, high resolution HDTV, and others. Selection allows a user to move between multiple panels of channel guide information. The navigation modes are designed to provide a user with freedom and control over the viewing area, making it possible to see a large body of information with a small display surface. An illustration of the effects of zooming is depicted in FIG. 2(a)-(c), with each successive frame, FIG. 2(a), 2(b), and 2(c) representing further zooming-in (or the reverse representing further zooming-out).

In addition to the panel-type view just described, the present invention also provides a user with an option to view all of the channels in the program database or a subset of the channels in the program database represented by a particular node by using a more traditional matrix-type display as shown in FIG. 1(b). This view “mode” is particularly useful when a user is looking for future programming and desires to use time as a dimension in the program guide.

Navigation control may be provided by several possible means, preferably through the use of a traditional remote control. The user may use various combinations of buttons and gestures or spoken language to signify a desired command, depending on the device used for user input. The navigation interface supports various gesturing devices with many buttons (or none) including wireless or corded mice, wireless pointers, and other devices that otherwise simulate two or three button mice. The speech recognition component can use standard speech recognition technologies to incorporate a dynamic, customizable language and grammar to allow a user to provide spoken commands to the interactive guide. Preferably, simple and easy-to-use phrases such as “go back”, “pick”, “zoom view”, “pan screen” may be used.

The interactive guide provides a user with tools to maneuver through large information databases to find specific content very quickly. It provides the user with the ability to use a low or high-resolution display to view information, even if it is in the form of small text. Finally, a user can control navigation with natural and intuitive gestures such as pointing and speaking to indicate his decisions, making it easy to use. By allowing the use of pointing and speaking, a user could, for example, simply move the cursor over media and say, “play this” or “take me there.” Allowing the use of simple phrases can make the user interface particularly friendly and intuitive. A user never needs to remember a name or know to what they are pointing.

The actions necessary to invoke commands are preferably abstracted away from the functionality itself, allowing hardware and command interfaces to be interchanged. Each component may be swapped based on user preferences or as new features and hardware become available.

Embodiments of the Present Invention

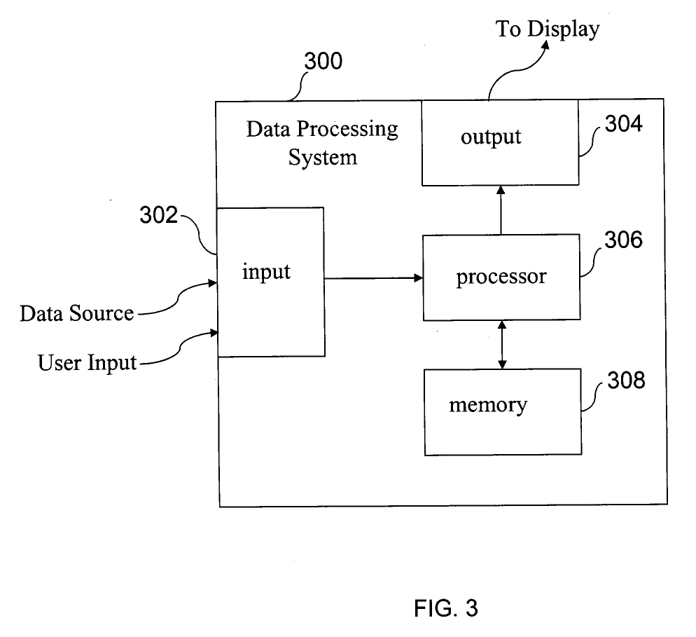

A block diagram depicting a computer (data processing system) that provides the functionality for the interactive guide is depicted in FIG. 3. The computer 300 includes an input 302 for receiving data from a media database such as from a cable provider, a modem/network, CDROM, a local database, or a satellite television network. The input 302 is also configured to receive user input from a user input device. Although shown as one block in FIG. 3, the input 302 generally takes the form of multiple physical inputs, e.g., the portion of the input 302 used for inputting data from the media data base is typically in the form of a coaxial cable input or an optical input, and the portion of the input 302 used for receiving user input is typically in the form of an infrared or RF receiver. The computer 300 also includes a processor connected with the input 302 for receiving commands and data therefrom. The processor 304 is also coupled with a memory 306 for storing data. The components of the memory 306 may be selected to fit a desired application, including not only chip and flash-based memories, but also hard drives, optical drives, or other types of memory. An output 308 is also connected with the processor 306 to provide visual output to a display device. As with the input 302, the output 308 may include multiple output types to suit various display devices, e.g., s-video, component video, etc. The output 308 of the computer may be configured to provide all of the necessary pre-display processing for outputting a video signal in a desired format, or such processing may be done externally. The exact technique for formatting the display signal prior to display on a display device is a design choice.

The processor 304 of the computer performs two functions. It acts as a command processor for receiving and interpreting user commands from a user input device, and it acts as a display processor to process input from the database based on the user commands in order to generate output for display on a display device.

The input 302 for receiving user input may be configured to receive input from a variety of devices or from a combination of several devices. Preferably, input is received wirelessly using a standard set of commands. Examples of input devices that could be used with the present invention include wireless remote controls such as those traditionally used with televisions, gesture recognition devices for recognizing input from a user in the form of a bodily movement, eye movement trackers, joystick-type remote controls similar to those commonly used with video games, and microphones coupled with voice recognition processors.

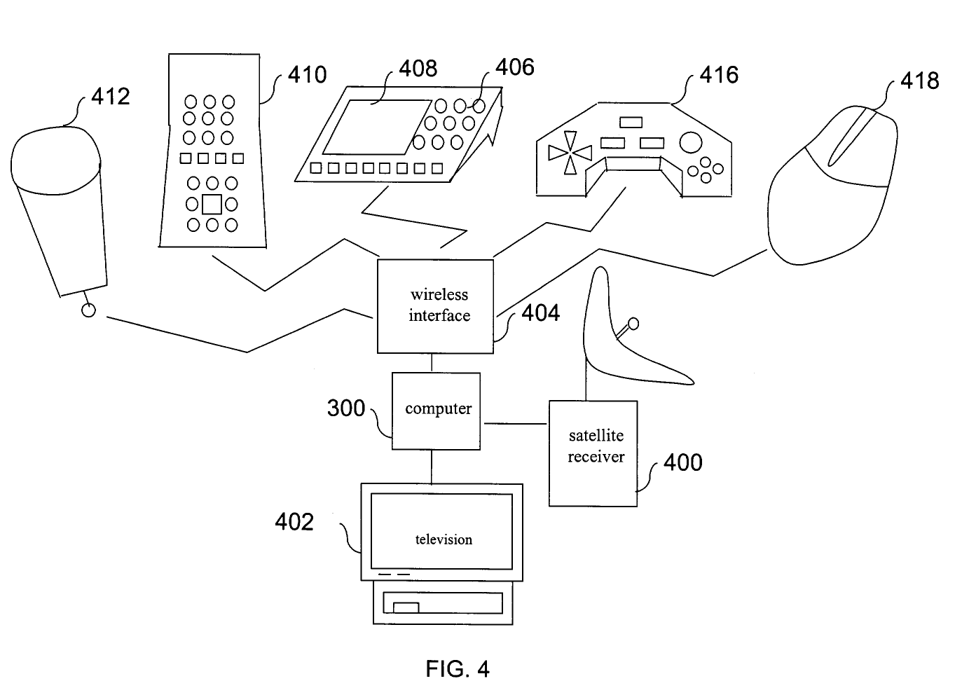

An example configuration of a hardware configuration of the present invention with various controls is depicted in the block diagram of FIG. 4. The computer 300 is connected with a satellite receiver 400 to receive programs from a program database and with a television 402 to generate a display. Additionally, the input of the computer 300 is shown with a wireless interface 404 to receive input from a variety of controls. Several examples of controls are provided, each using different means for receiving user commands. The examples include a touchpad-based remote control 406 which provides the user with a set of buttons as well as a touchpad 408 that allows a user to control the direction and speed of various operations such as panning and zooming. A traditional television remote control 410 is also depicted, which allows a user to control various functions through the use of buttons. A microphone 412 is shown, which provides a user with the ability to use simple speech-based commands to control functions of the system. In FIG. 4, it is assumed that speech recognition capability is embedded in the microphone, although such capability may also be provided in the computer 300 or in an external adapter (not shown). Also, a videogame-type input device 414 is shown, for example, with a joystick which can allow precise control over various functions of the interactive guide. Finally, a computer mouse 418 is shown, which could also be used to provide input.

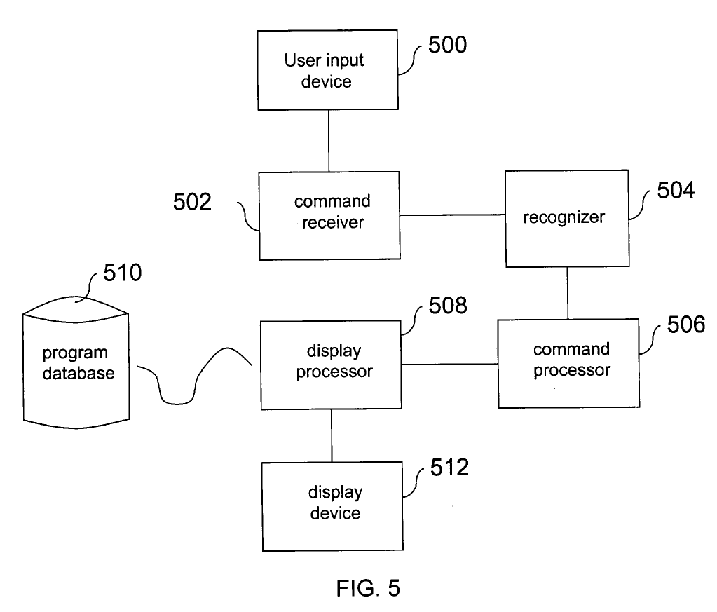

An alternate block diagram showing the components of the present invention is depicted in FIG. 5, wherein a user input device 500 provides a navigation choice input (command) to a command receiver 502, preferably a wireless interface 404 (of FIG. 4). The command receiver 502 provides the navigation choice input to a recognizer 504. The recognizer 504 is a device that interprets commands from the user input device 500 and could take the form of a voice recognizer, a gesture recognizer, or a simple look-up table to recognize commands from a remote control. Once a command has been recognized, it sent to the command processor 506 which drives the display processor 508 to process program data from a program database 510 for display on a display device 512. This design helps to facilitate modularity and scalability by using separate receivers and recognition components. With regard to gesture or speech recognition-based controls, when a gesture or phrase is recognized, a representative token is forwarded to the command processor 506. The command is then put into the context of the current state of the interactive guide. The display processor 508 then combines the commands and the appropriate information from the program (guide) database 510 to produce an image, text, sound, or video suitable for display on the display device 512.

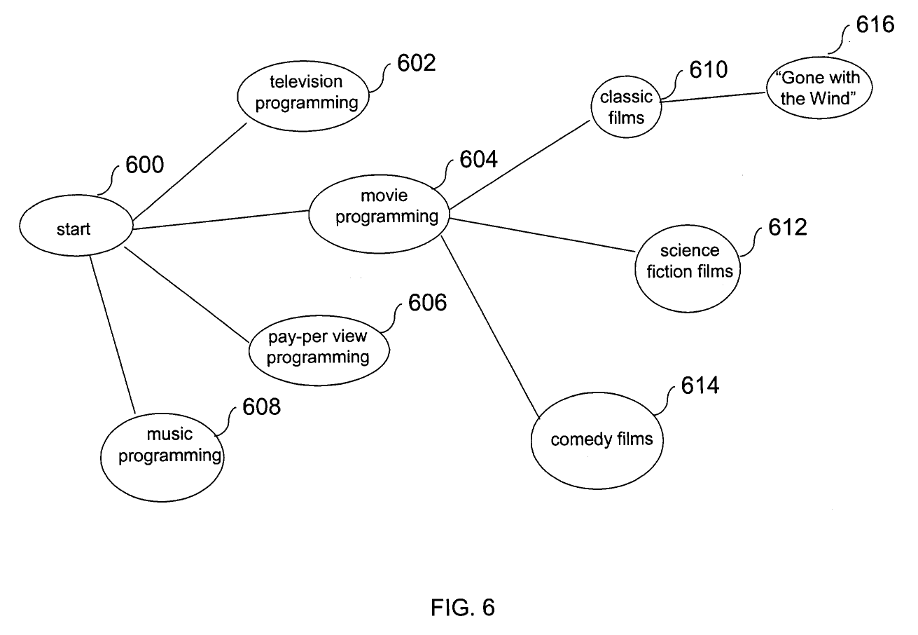

The present invention is designed to operate on multimedia sources stored in a program database in the form of a graph structure. Depending on the processing needs and available bandwidth of a particular system, the data from the graph structure used by the interactive guide for generation of its display may be downloaded in real-time from the program database, it may be sent periodically in a “batch mode” either over a data connection or physically in the form of a computer readable media, or it may be generated from the media sources and related metadata by the interactive guide's computer and stored locally. The graph structure may also be in a more specialized form such as a tree. The graph structure includes a starting node, at which the interactive guide begins to offer navigation options. Each point in the graph structure is termed herein as a “node”. Nodes in the graph may represent media sources (channels), or they may represent a group of links to other nodes, such as a topic. For example, a node in the graph could provide links to several country music stations. An illustrative example of a graph of depicting an organization of media sources (channels) is shown in FIG. 6. A starting node 600 provides an opening set of options to a user. As shown, and by way of example only, there are four selection options available from this the starting node 600, including television programming 602, movie programming 604, pay-per view programming 606, and music programming 608. Alternative and additional selection options can be substituted or added, e.g., videogame programming, etc. Each of these options are preferably represented in the form of an icon such as those depicted in FIG. 1(a). Selection of icons may take place through the use of a cursor or through other means such as gesture or voice recognition. Upon selection of an icon (node), e.g., pay-per-view programming 606, the computer 300 (of FIG. 3) displays a set of icons from the point of view of the selected icon. In the case of pay-per-view programming 606 (in this case, movies), the icons depicted next include, for example, classic films 610, science fiction films 612, and comedy films 614, or other icons for other film categories. If the user selects classic films 610, specific media icons 616 are displayed, e.g., “Gone with the Wind”, is displayed. Note that there are multiple paths for reaching this icon. In the graph, the node that serves as the current point of view for the interactive guide at any given time is termed the “current node”. Each node in the graph includes contents such as links to other nodes, multimedia contents, and contextual contents. Also, every node in the graph is either directly or indirectly connected with every other node through one or more paths.

As previously mentioned, a specific media icon may be in a variety of forms, possibly chosen by the end user. Specific media icons may be in the form of representative icons, such as miniature movie posters. On the other hand, they may take the form of a native format representation of the underlying media, e.g., sounds for sound files, miniature versions of movies and television shows playing in real time, etc. Once a specific media icon is selected, it begins playback using the full screen.

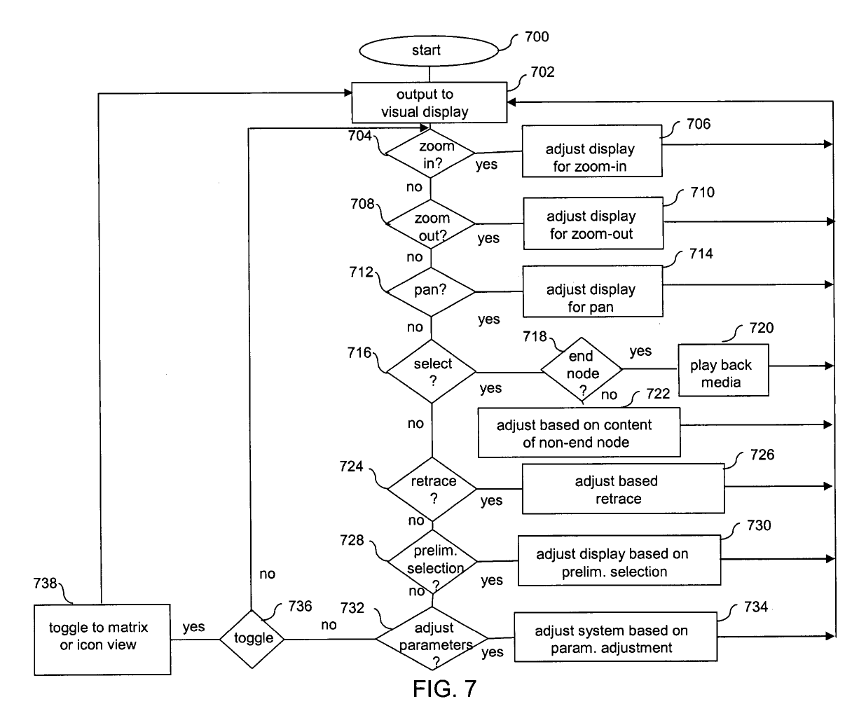

A flowchart detailing the core operations facilitated by the present invention is shown in FIG. 7. After the start of the operations 700, an output is provided to the visual display 702 by the interactive guide, e.g., the computer 300. Generally, the output comprises a plurality of icons such as that shown in FIG. 1(a). The interactive guide then awaits input of a user command. Note that although the commands are depicted in a sequence in FIG. 7, this is only for convenience of depiction; the actual sequence is of no particular consequence, and the detection of operations may be thought of as occurring essentially simultaneously.

The interactive guide awaits a possible zoom-in command 704. If a zoom-in command is received, the display is adjusted to show more detail 706. Zooming may take place in many different ways. For example, on a typical television remote control, a user may zoom around the current location of the cursor by pressing +/− zooming buttons. On the other hand, in another embodiment using a touch pad, the user may control the level of zooming by moving their fingers across the touch pad or by outlining an area of the screen to be zoomed in on so that it fills the television screen. The results of the zoom-in command are then sent to the visual display 702 by the interactive guide, thus updating the display. For example, at a zooming level that displays many icons, it may be difficult or impossible to discern details of each. The user may then desire to zoom in to see more information regarding the subject matter of a subset of the icons.

The interactive guide also awaits a possible zoom-out command 708. The zoom-out command is used to adjust the display to show less detail 710, but a greater number of features. Zooming-out operates in a manner similar to that of zooming-in, but in the opposite direction. The results of the zoom-out command are then sent to the visual display 702 by the interactive guide, thus updating the display. For example, at a zooming level that displays only a few icons, it may be very inconvenient to see all of the icons by panning around on the screen. Thus, the user may desire to zoom out to get a broader overview of the icons visible from the current node. In the process, the user sacrifices detail regarding particular icons, but is provided with a much better overview of the selections possible. The zoom-out command may be provided, for example, from the user to the computer 300 through the use of +/− buttons on a television remote control.

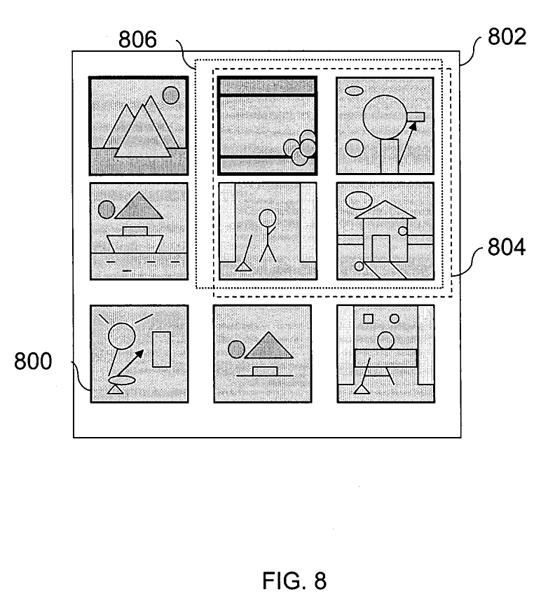

The interactive guide further awaits a pan command 712. In some cases, for example, when there are many icons and a user has zoomed in to view greater details, the television screen acts as a “window” through which a small portion of a larger “area” of icons is visible. With the pan command, the user is able to move the window to other portions of the area to view other icons. An illustrative depiction of panning, as the term is used herein is shown in FIG. 8. All icons 800 viewable from a particular node are represented in an area 802. The portion of the area 802 visible from on the television screen is depicted by a dashed rectangle 804. To view icons that are not visible in the dotted rectangle 806, the user can zoom out, in which case the area of the dashed rectangle 804 would increase, displaying more icons but with less detail, or the user can issue a panning command to move the visible portion of the area 802 by, in essence, shifting the position of the dashed rectangle 804. In FIG. 8, the dotted rectangle 806 represents the dashed rectangle 804 after movement. The pan command may be facilitated by directional buttons on a television remote control. However, use of a device that is sensitive for providing information both on the direction to move and the speed at which to move is preferable. The display information is adjusted to reflect the results of the panning operation 714, and the results are then sent to the visual display 702 by the interactive guide, thus updating the display.

The interactive guide also awaits a selection command 716. The selection command performs two functions, depending on the content of an icon selected. If the icon selected is a program or piece of media, in other words, an end node 718, the program or piece of media is played back by the visual display 720 and the program is sent to the visual display 702 by the interactive guide, thus updating the display. If the icon selected represents a non-terminal node, typically with links to other nodes, then icons representing nodes linked to the icon (node) selected are displayed on the television. Once a selection of an icon representing a non-terminal node is made, the display information is adjusted to reflect the result of the selection command 722, and the program is sent to the visual display 702 by the interactive guide, thus updating the display.

The interactive guide further awaits a retrace command 724. The retrace command is used to back up to the last node visited (the immediately previous node). Referring back to FIG. 6, if the interactive guide is currently at the pay-per-view node 606, the retrace command would cause the interactive guide to go back to the start node 600. After a retrace command is issued, the display information is adjusted to reflect the results of the retrace operation 726, and the results are then sent to the visual display 702 by the interactive guide, thus updating the display.

The interactive guide can optionally support a preliminary selection command 728. If a preliminary selection is made, the icon selected is highlighted or amplified in some fashion. For example, with an audio icon, the underlying sound may begin to play; or with a video icon, the video may begin playing, may be highlighted by a change in brightness or coloring, or in other ways. Preliminary selection can provide a user with a preview of the media content, and can be performed, for example, by moving a cursor over a particular icon or by an explicit preselection command, for example, a specific button, vocal command, or gesture may be used to perform the preselection. After a preselection is performed, the display information is adjusted to reflect the results of the preliminary selection operation 730, and the results are then sent to the visual display 702 by the interactive guide, thus updating the display.

The operating parameters of the interactive guide can also be adjusted by a parameter adjusting command 732. Parameters that can be adjusted include the speed at which the interactive guide zooms and pans, allowing users to adjust for differences in their personal reflexes. For example, less agile people or others with slower reflexes may want to slow down the response speed of the interactive guide so that they can control it better. The operating parameters may be adjusted through an on-screen display table or through specific controls on the remote control. If a user adjusts the parameters of the interactive guide, the response of the commands are tailored based on the parameter adjustment 734, and the results, if applicable, are sent to the visual display 702 by the interactive guide, thus updating the display.

Besides the icon-style display, it may be desirable, at times, to allow a user to choose to display program information in a tabular form using a matrix display command 736. Typically, the matrix display command is issued using a toggle-type switch that allows a user to toggle between a icon-style display and a matrix-style display as depicted in FIG. 1(a) and FIG. 1(b), respectively. If a user toggles from an icon display to a matrix display, or vice-versa, the display information is adjusted to reflect the results of the toggle operation 738, and the results are then sent to the visual display 702 by the interactive guide, thus updating the display. The matrix display can be used to display the programs from the vantage point of a particular node in tabular form, or it can be used to display all of the program channels in the program database in a single large table, which can be sorted in varying manners. Preferably, the programs (channels) are lined up as rows extending along the horizontal axis of the table. The horizontal axis, itself, is in the form of a timeline. This allows a user to search for future programming on particular channels. Note that depending on the type of programming, time-based searching may not be applicable, e.g. in the case of video-on-demand programming.

In addition to the icon-style and matrix-style displays depicted in FIGS. 1(a) and 1(b), respectively, the nodes of the graph structure may also be simply linked, perhaps sorted by a user's interests, thus forming a degenerate graph which a user can “channel surf.” Other methods of sorting may be used for linking the nodes in this manner, examples of which include sorting by content type, sorting by program length, etc.

As stated previously, the present invention provides an apparatus, a method, and a computer program product to provide an interactive guide for television program selection. Although the flow chart depicted in FIG. 7 has been described from the standpoint of operations in the apparatus of the present invention, each operation maps to both the “steps” in the method and to the “means” in the apparatus and the computer program product. Also, although the steps and means of the various embodiments of the present invention are discussed in a particular order herein, they are presented both here, and in the claims, in this order simply for convenience. Their actual performance may be in any order that enables the invention to function properly. The actual order selected will depend on the specific needs of an embodiment, and is readily determinable by one skilled in the art.

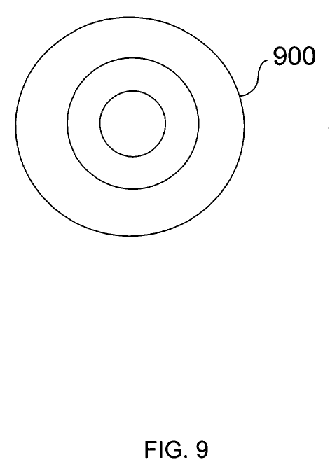

An illustrative diagram of a computer program product embodying the present invention is depicted in FIG. 9. The computer program product 900 is depicted as an optical disk such as a CD or a DVD, but other media such as tapes, cards, etc. may be used. As mentioned previously, the computer program product generally represents computer readable code stored on any compatible computer readable media. Each of the steps described with regard to the method of the present invention are generally written onto the computer program product in the form of means, which are embodied as computer program code.

What is claimed is:

1. An interactive multimedia selection apparatus comprising a computer system including a processor, a memory coupled with the processor, a first input coupled with the processor for receiving user input, a second input coupled with the processor for receiving data from a program database, and an output coupled with the processor for sending display information to a visual display, wherein the computer system further comprises means, operating in its processor and memory, for navigating through a graph structure of multimedia sources in the program database, where the graph structure includes a plurality of nodes including a starting node, a current node representing a current point of view in the graph structure of the means for navigating, and a plurality of connected nodes, where the connected nodes are connected with the starting node through the graph structure, and where each of the nodes represents at least one type of content selected from a group of links to other nodes, multimedia contents, and contextual information, the means for navigating including means for:
a. providing an output to a visual display with the output including icons representing nodes directly connected with current node;
b. receiving user input in the form of a user command through the first input into the computer system for controlling the navigation of the interactive multimedia selection apparatus to allow the user to cause panning of the visual display, zooming-in of a desired portion of the visual display, zooming-out of a desired portion of the visual display, selection of a node represented by an icon, and retracing;
c. in response to a user command for panning, sending display information through the output to the visual display to effect a panning action in order to cause the icons to move in a panning motion on the display in order to provide the user with a better view of the icons;
d. in response to a user command for zooming in, sending display information through the output to the visual display to effect a zooming-in action in order to allow the user to see more detail in a desired portion of the visual display;
e. in response to a user command for zooming out, sending display information through the output to the visual display to effect a zooming-out action in order to allow the user to see a larger area of the visual display;
f. in response to a user command for selecting a node represented by an icon, sending display information through the output to the visual display to effect an opening of the respective node to display its contents on the visual display; and
g. in response to a user command for retracing, sending display information through the output to the visual display to navigate to the immediately previous current node.

2. An interactive multimedia selection apparatus as set forth in claim 1, wherein the nodes are represented in the visual display by information sent through the output as graphical icons, with each icon depicting a representation of the content in the database represented by the node.

3. An interactive multimedia selection apparatus as set forth in claim 2, wherein icons, representing nodes including multimedia content, play a reduced version of the multimedia content in real-time, thereby allowing a user to sense the underlying content of a media source prior to deciding whether to receive a full version of the content.

4. An interactive multimedia selection apparatus as set forth in claim 3, wherein the user input includes a selection means that allows a user perform a preliminary selection in which an icon preliminarily selected is enhanced so that its multimedia play is amplified relative to that of the other icons, whereby the multimedia content play of a preliminarily selected icon stands out from the other icons to allow a user to better determine its contents.

5. An interactive multimedia selection apparatus as set forth in claim 4, wherein the first input includes a user input device selected from a group consisting of television remote controls, computer mice, microphones, and eye-trackers.

6. An interactive multimedia selection apparatus as set forth in claim 5, wherein the apparatus further comprises a visual display device for receiving output from the processor for display to a user.

7. An interactive multimedia selection apparatus as set forth in claim 6, wherein the means for navigating further comprises a means for displaying all of the multimedia sources in the program database in a timeline matrix structure; whereby a user may also browse through the multimedia sources to search for desired content.

8. An interactive multimedia selection apparatus as set forth in claim 7, wherein the means for navigating further comprises a means for adjusting the response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

9. An interactive multimedia selection apparatus as set forth in claim 2, wherein icons, representing nodes including multimedia content, play a reduced version of the multimedia content in real-time, thereby allowing a user to sense the underlying content of a media source prior to deciding whether to receive a full version of the content.

10. An interactive multimedia selection apparatus as set forth in claim 9, wherein the first input includes a user input device selected from a group consisting of television remote controls, computer mice, microphones, and eye-trackers.

11. An interactive multimedia selection apparatus as set forth in claim 10, wherein the apparatus further comprises a visual display device for receiving output from the processor for display to a user.

12. An interactive multimedia selection apparatus as set forth in claim 11, wherein the means for navigating further comprises a means for displaying all of the multimedia sources in the program database in a timeline matrix structure; whereby a user may also browse through the multimedia sources to search for desired content.

13. An interactive multimedia selection apparatus as set forth in claim 12, wherein the means for navigating further comprises a means for adjusting the response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

14. An interactive multimedia selection apparatus as set forth in claim 1, wherein the means for navigating further comprises a means for displaying all of the multimedia sources in the program database in a timeline matrix structure; whereby a user may also browse through the multimedia sources to search for desired content.

15. An interactive multimedia selection apparatus as set forth in claim 14, wherein the means for navigating further comprises a means for adjusting the response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

16. An interactive multimedia selection apparatus as set forth in claim 1, wherein the icons representing the nodes are represented in the visual display by information sent through the output as a native format representation, with each native format representation depicting a representation of the multimedia and contextual information in the database represented by the node.

17. An interactive multimedia selection apparatus as set forth in claim 16, wherein icons, representing nodes including multimedia content, play a reduced version of the multimedia content in real-time, thereby allowing a user to sense the underlying content of a media source prior to deciding whether to receive a full version of the content.

18. An interactive multimedia selection apparatus as set forth in claim 17, wherein the user input includes a selection means that allows a user perform a preliminary selection in which a native format representation preliminarily selected is enhanced so that its multimedia play is amplified relative to that of the other native format representations, whereby the multimedia content play of a preliminarily selected native format representation stands out from the other native format representations to allow a user to better determine its contents.

19. An interactive multimedia selection apparatus as set forth in claim 18, wherein the first input includes a user input device selected from a group consisting of television remote controls, computer mice, microphones, and eye-trackers.

20. An interactive multimedia selection apparatus as set forth in claim 19, wherein the apparatus further comprises a visual display device for receiving output from the processor for display to a user.

21. An interactive multimedia selection apparatus as set forth in claim 20, wherein the means for navigating further comprises a means for displaying all of the multimedia sources in the program database in a timeline matrix structure; whereby a user may also browse through the multimedia sources to search for desired content.

22. An interactive multimedia selection apparatus as set forth in claim 21, wherein the means for navigating further comprises a means for adjusting the response of the apparatus to the user input in order to adjust the speed of the panning of the visual display, zooming-in of a desired portion of the visual display, zooming-out of a desired portion of the visual display, selection of a node represented by a native format representation, and retracing so that the response of the apparatus may be tailored to the needs of a particular user.

23. An interactive multimedia selection apparatus as set forth in claim 16, wherein icons, representing nodes including multimedia content, play a reduced version of the multimedia content in real-time, thereby allowing a user to sense the underlying content of a media source prior to deciding whether to receive a full version of the content.

24. An interactive multimedia selection apparatus as set forth in claim 23, wherein the first input includes a user input device selected from a group consisting of television remote controls, computer mice, microphones, and eye-trackers.

25. An interactive multimedia selection apparatus as set forth in claim 24, wherein the apparatus further comprises a visual display device for receiving output from the processor for display to a user.

26. An interactive multimedia selection apparatus as set forth in claim 25, wherein the means for navigating further comprises a means for displaying all of the multimedia sources in the program database in a timeline matrix structure; whereby a user may also browse through the multimedia sources to search for desired content.

27. An interactive multimedia selection apparatus as set forth in claim 26, wherein the means for navigating further comprises a means for adjusting the response of the apparatus to the user input in order to adjust the speed of the panning of the visual display, zooming-in of a desired portion of the visual display, zooming-out of a desired portion of the visual display, selection of a node represented by a native format representation, and retracing so that the response of the apparatus may be tailored to the needs of a particular user.

28. An method for interactive multimedia selection apparatus comprising a computer system including a processor, a memory coupled with the processor, a first input coupled with the processor for receiving user input, a second input coupled with the processor for receiving data from a program database, and an output coupled with the processor for sending display information to a visual display, wherein the computer system further comprises means, operating in its processor and memory, for navigating through a graph structure of multimedia sources in the program database, where the graph structure includes a plurality of nodes including a starting node, a current node representing a current point of view in the graph structure of the means for navigating, and a plurality of connected nodes, where the connected nodes are connected with the starting node through the graph structure, and where each of the nodes represents at least one type of content selected from a group of links to other nodes, multimedia contents, and contextual information, the method for interactive television selection comprising steps of:
a. providing an output to a visual display with the output including icons representing nodes directly connected with current node;
b. receiving user input in the form of a user command through the first input into the computer system for controlling the navigation of the interactive multimedia selection apparatus to allow the user to cause panning of the visual display, zooming-in of a desired portion of the visual display, zooming-out of a desired portion of the visual display, selection of a node represented by an icon, and retracing;
c. in response to a user command for panning, sending display information through the output to the visual display to effect a panning action in order to cause the icons to move in a panning motion on the display in order to provide the user with a better view of the icons;
d. in response to a user command for zooming in, sending display information through the output to the visual display to effect a zooming-in action in order to allow the user to see more detail in a desired portion of the visual display;
e. in response to a user command for zooming out, sending display information through the output to the visual display to effect a zooming-out action in order to allow the user to see a larger area of the visual display;
f. in response to a user command for selecting a node represented by an icon, sending display information through the output to the visual display to effect an opening of the respective node to display its contents on the visual display; and
g. in response to a user command for retracing, sending display information through the output to the visual display to navigate to the immediately previous current node.

29. A method for interactive multimedia selection as set forth in claim 28, wherein in the step of providing an output to a visual display, the nodes are represented in the display information sent through the output as graphical icons, with each icon depicting a representation of the content in the database represented by the node.

30. A method for interactive multimedia selection as set forth in claim 29, wherein in the step of providing an output to a visual display, the icons, representing nodes including multimedia content, play a reduced version of the multimedia content in real-time, thereby allowing a user to sense the underlying content of a media source prior to deciding whether to receive a full version of the content.

31. A method for interactive multimedia selection as set forth in claim 30, further comprising a step of preliminarily selecting wherein in response to a user performing a preliminary selection of an icon, the icon preliminarily selected is enhanced so that its multimedia play is amplified relative to that of the other icons, whereby the multimedia content play of a preliminarily selected icon stands out from the other icons to allow a user to better determine its contents.

32. A method for interactive multimedia selection as set forth in claim 31, wherein the method further comprises a step of displaying all of the multimedia sources in the program database in a timeline matrix structure in response to a user request; whereby a user may also browse through the multimedia sources to search for desired content.

33. A method for interactive multimedia selection as set forth in claim 32, wherein the method further comprises a step of adjusting a response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

34. A method for interactive multimedia selection as set forth in claim 29, further comprising a step of preliminarily selecting wherein in response to a user performing a preliminary selection of an icon, the icon preliminarily selected is enhanced so that its multimedia play is amplified relative to that of the other icons, whereby the multimedia content play of a preliminarily selected icon stands out from the other icons to allow a user to better determine its contents.

35. A method for interactive multimedia selection as set forth in claim 34, wherein the method further comprises a step of displaying all of the multimedia sources in the program database in a timeline matrix structure in response to a user request; whereby a user may also browse through the multimedia sources to search for desired content.

36. A method for interactive multimedia selection as set forth in claim 35, wherein the method further comprises a step of adjusting a response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

37. A method for interactive multimedia selection as set forth in claim 28, wherein the method further comprises a step of displaying all of the multimedia sources in the program database in a timeline matrix structure in response to a user request; whereby a user may also browse through the multimedia sources to search for desired content.

38. A method for interactive multimedia selection as set forth in claim 37, wherein the method further comprises a step of adjusting a response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

39. A method for interactive multimedia selection set forth in claim 28, wherein in the step of providing an output to a visual display, the icons representing the nodes are represented in the display information sent through the output as a native format representation, with each native format representation depicting a representation of the multimedia and contextual information in the database represented by the node.

40. A method for interactive multimedia selection as set forth in claim 39, wherein in the step of providing an output to a visual display, the icons, representing nodes including multimedia content, play a reduced version of the multimedia content in real-time, thereby allowing a user to sense the underlying content of a media source prior to deciding whether to receive a full version of the content.

41. A method for interactive multimedia selection as set forth in claim 40, further comprising a step of preliminarily selecting wherein in response to a user performing a preliminary selection of a native format representation, the native format representation preliminarily selected is enhanced so that its multimedia play is amplified relative to that of the other native format representations, whereby the multimedia content play of a preliminarily selected native format representation stands out from the other native format representations to allow a user to better determine its contents.

42. A method for interactive multimedia selection as set forth in claim 41, wherein the method further comprises a step of displaying all of the multimedia sources in the program database in a timeline matrix structure in response to a user request; whereby a user may also browse through the multimedia sources to search for desired content.

43. A method for interactive multimedia selection as set forth in claim 42, wherein the method further comprises a step of adjusting a response of the apparatus to the user input in order to adjust the speed of the panning of the visual display, zooming-in of a desired portion of the visual display, zooming-out of a desired portion of the visual display, selection of a node represented by a native format representation, and retracing so that the response of the apparatus may be tailored to the needs of a particular user.

44. A method for interactive multimedia selection as set forth in claim 39, further comprising a step of preliminarily selecting wherein in response to a user performing a preliminary selection of a native format representation, the native format representation preliminarily selected is enhanced so that its multimedia play is amplified relative to that of the other native format representations, whereby the multimedia content play of a preliminarily selected native format representation stands out from the other native format representations to allow a user to better determine its contents.

45. A method for interactive multimedia selection as set forth in claim 44, wherein the method further comprises a step of displaying all of the multimedia sources in the program database in a timeline matrix structure in response to a user request; whereby a user may also browse through the multimedia sources to search for desired content.

46. A method for interactive multimedia selection as set forth in claim 45, wherein the method further comprises a step of adjusting a response of the apparatus to the user input in order to adjust the speed of the panning of the visual display, zooming-in of a desired portion of the visual display, zooming-out of a desired portion of the visual display, selection of a node represented by a native format representation, and retracing so that the response of the apparatus may be tailored to the needs of a particular user.

47. A computer program product for interactive multimedia selection for use with a computer system including a processor, a memory coupled with the processor, a first input coupled with the processor for receiving user input, a second input coupled with the processor for receiving data from a program database, and an output coupled with the processor for sending display information to a visual display, wherein the computer system further comprises means, operating in its processor and memory, for navigating through a graph structure of multimedia sources in the program database, where the graph structure includes a plurality of nodes including a starting node, a current node representing a current point of view in the graph structure of the means for navigating, and a plurality of connected nodes, where the connected nodes are connected with the starting node through the graph structure, and where each of the nodes represents at least one type of content selected from a group of links to other nodes, multimedia contents, and contextual information, the computer program product comprising means for:
a. providing an output to a visual display with the output including icons representing nodes directly connected with current node;
b. receiving user input in the form of a user command through the first input into the computer system for controlling the navigation of the interactive multimedia selection apparatus to allow the user to cause panning of the visual display, zooming-in of a desired portion of the visual display, zooming-out of a desired portion of the visual display, selection of a node represented by an icon, and retracing;
c. in response to a user command for panning, sending display information through the output to the visual display to effect a panning action in order to cause the icons to move in a panning motion on the display in order to provide the user with a better view of the icons;
d. in response to a user command for zooming in, sending display information through the output to the visual display to effect a zooming-in action in order to allow the user to see more detail in a desired portion of the visual display;
e. in response to a user command for zooming out, sending display information through the output to the visual display to effect a zooming-out action in order to allow the user to see a larger area of the visual display;
f. in response to a user command for selecting a node represented by an icon, sending display information through the output to the visual display to effect an opening of the respective node to display its contents on the visual display; and
g. in response to a user command for retracing, sending display information through the output to the visual display to navigate to the immediately previous current node.

48. A computer program product for interactive multimedia selection as set forth in claim 47, wherein the means for providing output to a visual display represents the nodes in the visual display by information sent through the output as graphical icons, with each icon depicting a representation of the content in the database represented by the node.

49. A computer program product for interactive multimedia selection as set forth in claim 48, wherein the means for providing an output to a visual display represents the icons, representing nodes by playing a reduced version of the multimedia content in real-time, thereby allowing a user to see the underlying content of a media source prior to deciding whether to receive a full version of the content.

50. A computer program product for interactive multimedia selection as set forth in claim 49, further comprising a means for preliminarily selecting wherein in response to a user performing a preliminary selection of an icon, the icon preliminarily selected is enhanced so that its multimedia play is amplified relative to that of the other icons, whereby the multimedia content play of a preliminarily selected icon stands out from the other icons to allow a user to better determine its contents.

51. A computer program product for interactive multimedia selection as set forth in claim 50, further comprising a means for displaying all of the multimedia sources in the program database in a timeline matrix structure in response to a user request; whereby a user may also browse through the multimedia sources to search for desired content.

52. A computer program product for interactive multimedia selection as set forth in claim 51, further comprising a means for adjusting a response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

53. A computer program product for interactive multimedia selection as set forth in claim 48, further comprising a means for preliminarily selecting wherein in response to a user performing a preliminary selection of an icon, the icon preliminarily selected is enhanced so that its multimedia play is amplified relative to that of the other icons, whereby the multimedia content play of a preliminarily selected icon stands out from the other icons to allow a user to better determine its contents.

54. A computer program product for interactive multimedia selection as set forth in claim 53, further comprising a means for displaying all of the multimedia sources in the program database in a timeline matrix structure in response to a user request; whereby a user may also browse through the multimedia sources to search for desired content.

55. A computer program product for interactive multimedia selection as set forth in claim 54, further comprising a means for adjusting a response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

56. A computer program product for interactive multimedia selection as set forth in claim 47, further comprising a means for displaying all of the multimedia sources in the program database in a timeline matrix structure in response to a user request; whereby a user may also browse through the multimedia sources to search for desired content.

57. A computer program product for interactive multimedia selection as set forth in claim 56, further comprising a means for adjusting a response of the apparatus to the user input in order to adjust the speed of the panning of the visual display, zooming-in of a desired portion of the visual display, zooming-out of a desired portion of the visual display, selection of a node represented by an icon, and retracing so that the response of the apparatus may be tailored to the needs of a particular user.

58. A computer program product for interactive multimedia selection as set forth in claim 47, wherein in the means for providing an output to a visual display, the icons representing the nodes are represented in the visual display by information sent through the output as a native format representation, with each native format representation depicting a representation of the multimedia and contextual information in the database represented by the node.

59. A computer program product for interactive multimedia selection as set forth in claim 58, wherein the means for providing an output to a visual display represents the native format representations representing nodes by playing a reduced version of the multimedia content in real-time, thereby allowing a user to see the underlying content of a media source native format representation prior to fully viewing the content.

60. A computer program product for interactive multimedia selection as set forth in claim 59, further comprising a means for preliminarily selecting wherein in response to a user performing a preliminary selection of a native format representation, the native format representation preliminarily selected is enhanced so that its multimedia play is amplified relative to that of the other native format representations, whereby the multimedia content play of a preliminarily selected native format representation stands out from the other native format representations to allow a user to better determine its contents.

61. A computer program product for interactive multimedia selection as set forth in claim 60, further comprising a means for displaying all of the multimedia sources in the program database in a timeline matrix structure in response to a user request; whereby a user may also browse through the multimedia sources to search for desired content.

62. A computer program product for interactive multimedia selection as set forth in claim 61, further comprising a means for adjusting a response of the apparatus to the user input in order to adjust the speed of the panning of the visual display, zooming-in of a desired portion of the visual display, zooming-out of a desired portion of the visual display, selection of a node represented by a native format representation, and retracing so that the response of the apparatus may be tailored to the needs of a particular user.

63. A computer program product for interactive multimedia selection as set forth in claim 58, further comprising a means for preliminarily selecting wherein in response to a user performing a preliminary selection of a native format representation, the native format representation preliminarily selected is enhanced so that its multimedia play is amplified relative to that of the other native format representations, whereby the multimedia content play of a preliminarily selected native format representation stands out from the other native format representations to allow a user to better determine its contents.

64. A computer program product for interactive multimedia selection as set forth in claim 63, further comprising a means for displaying all of the multimedia sources in the program database in a timeline matrix structure in response to a user request; whereby a user may also browse through the multimedia sources to search for desired content.

65. A computer program product for interactive multimedia selection as set forth in claim 64, further comprising a means for adjusting a response of the apparatus to the user input in order to adjust the speed of the panning of the visual display, zooming-in of a desired portion of the visual display, zooming-out of a desired portion of the visual display, selection of a node represented by a native format representation, and retracing so that the response of the apparatus may be tailored to the needs of a particular user.
